(19) United States
(12) Patent Application Publication
(10) Pub. No.: US 2010/0057793 A1
(43) Pub. Date: Mar. 4, 2010

(54) System and Method for Disseminating and Transferring Contact Information

(76) Inventors: Ari Goldberg, Teaneck, NJ (US); Alex Paskie, Brooklyn, NY (US); Richard Chalme, Brooklyn, NY (US); Isaac Levy, Brooklyn, NY (US)

Correspondence Address: LEVISOHN, BERGER , LLP, 11 BROADWAY , Suite 615, NEW YORK, NY, 10004, US

(21) Appl. No.: 12/510,989

(22) Filed: Jul. 28, 2009

Related U.S. Application Data
(60) Provisional application No. 61/084,135, filed on Jul. 28, 2008.

(51) Int. Cl. G06F 17/30

(52) U.S. Cl. 707/620; 707/E17.01

(57) ABSTRACT

A web-based system and method for sending, receiving and updating contact information. A subscriber of the inventive system provides contact information that is stored in a database. A unique code is generated by the system that is associated with the contact information. The system provides a website, at which a user who enters a unique code can important the contact information associated with the code directly into his/her personal information manager (PIM).

### RELATED APPLICATIONS

This application claims the benefit of U.S Provisional Appl. Ser. No. 61/084,135 filed on Jul. 28, 2008, the contents of which are incorporated by reference herein

### FIELD OF THE INVENTION

The current invention relates generally to the field of personal information managers (PIMs), more specifically to a system and method for inputting information into electronic databases based on a unique code

### BACKGROUND OF THE INVENTION

The use of specialized computer programs and electronic address books have become extremely popular, and increasingly, the preferred method for businesses, organizations and individuals to store contact information These electronic address books (referred to interchangeably herein as personal information managers or PIMs) achieve the same function as their predecessor Rolodex cards, but in a significantly more efficient and organized manner

Specifically, these computer programs or electronic address books provide a user with a form having blank fields for entering information therein. Each of the fields is uniquely labeled to receive a particular item of information For example, unique fields are provided for the entry of a first name, last name, street address, city, state, zip, phone number, etc. After information is entered into the various fields—it is saved in a database.

These systems present numerous advantages over prior, paper-based systems. The electronic files are intuitively organized, searchable, printable and they can be easily backed up—thus greatly reducing the risk of loss.

However, there also are disadvantages associated with these systems. The amount of contact information associated with each contact keeps increasing over time. For example, there can be multiple telephone numbers, mobile numbers, e-mail and web addresses associated with just one contact. All this information must be manually keyed into corresponding fields on the database—making it a possibly arduous process that is prone to human error.

A prior attempt to ameliorate some of these deficiencies is a system marketed under the name PLAXO. In that system, upon the initiation of a user, a message is sent to all contacts (recipients) in that particular user's (sender) address book—which allows for the sender's contact information to be imported into the recipients' respective address books. This system allows a sender to send out updated contact information to recipients anytime an item of information is changed.

However, in the PLAXO system, a sender must first have a recipient's e-mail address as a prerequisite to sending contact information. This limits the PLAXO system in two principal ways. Firstly, a user can only send contact information to a recipient with whom he/she has some sort of pre-existing relationship. The system therefore, does not cover the most common scenario in which information is exchanged—namely between two parties who have not previously met nor have any pre-existing relationship. Moreover, a potential recipient is powerless to import contact information on his/her own, but rather such receipt of information is dependant on a sender positively leaching out and sending the same.

### SUMMARY OF THE INVENTION

These deficiencies are overcome and other advantages are realized by the current invention, whereby a recipient who is in possession of a sender's unique code can easily import the sender's complete contact information into his/her personal information manager using only the sender's unique code. In this novel paradigm, a unique code is all that is required in order to import all of a sender's contact information into a recipient's electronic address book or PIM.

In the inventive system, a specialized website allows for subscribers to enter their contact information and obtain a unique code that is associated therewith. The unique code is then disseminated in any of various ways. For example, it can be displayed on a subscriber's business card, in an e-mail signature block or on stationary. A recipient having access to the unique code visits a website which prompts the recipient to key in the code. Upon correctly keying the code, all contact information that is represented by the same can be automatically imported into a recipient's address book.

This presents a vast improvement over the manual keying required by the prior art. With the system of the current invention, one who accumulates a large number of business cards or the like—all containing unique codes—can accurately enter all of the information contained thereon in a fraction of the time it would have otherwise taken. Moreover, in an embodiment of the invention, a subscriber's unique code is embedded in the contact information transmitted to a recipient—thus enabling for such contact information to be automatically updated by the website which searches for embedded codes in a recipient's address book.

### BRIEF DESCRIPTION OF THE DRAWINGS

FIG. 1 is a block diagram showing a system structure and interface according to an embodiment of the invention.

FIG. 2 is a block diagram showing the steps of importing contact information according to an embodiment of the invention. FIG. 3 is a screen capture of a webpage for importing contact information according to an embodiment of the invention.

FIG. 4 is a flow chart showing the steps associated with transmitting and receiving contact information according to an embodiment of the invention.

FIG. 5 is a flow chart showing the steps of synchronizing contact information according to an embodiment of the invention.

### DETAILED DESCRIPTION OF THE DRAWINGS

Embodiments of the present invention will now be described with reference to the above-identified Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

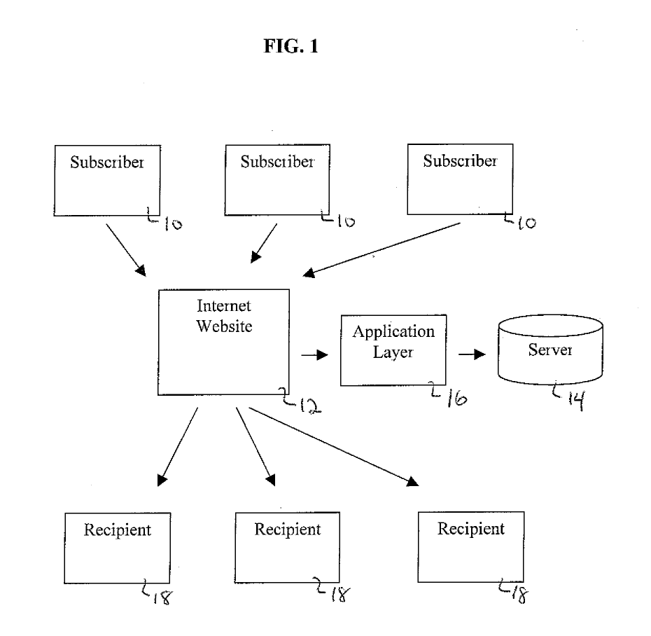

FIG. 1 shows a plurality of subscribers 10 (“subscriber(s)” here in refers to those inputting contact information to be distributed to others) accessing an Internet website 12 Subscribers 10 are prompted by the website 12 to enter contact information such as, but not limited to, name, company/organization name, street address, mailing address, e-mail address, phone numbers and other contact information—which are stored in one or more databases on one or more servers 14. Contact information refers to any information inputted by a subscriber to be transmitted and stored in a recipient's personal information manager. As shown, an application layer 16 mediates information entered through the website to be stored in the database on one or more servers 14.

Upon inputting desired contact information through the website, a unique code is generated which is a Primary Key for accessing that particular contact information.

Also shown in FIG. 1 is a plurality of recipients 18 (“recipients” herein refer to users who receive contact information from the website) accessing the website 12 Upon receiving a subscriber's unique code—for example, by receiving a subscriber's business card displaying the code—a user accessing the website can allow for the contact information represented by that particular code to be directly imported into his/her address book. For convenience, the domain name for the website 12 can be displayed together with the unique code—thereby directing recipients thereto.

There are several different address books that are widely used—each having a unique format For example MICROSOFT's Outlook, GOOGLE's Gmail and YAHOO's Yahoo Mail are each commonly used by a variety of individuals and entities. Thus, the current system must be configured to allow users of each of these products/platforms to be able to import data into their respective address books.

To that end, in one embodiment of the invention, each subscriber's contact information is stored in various databases—each of which is configured to map to a particular address book or platform. For example, information stored in rows and columns in a first database map to fields in MICROSOFT's Outlook, whereas the same information stored in a second database map to fields in GOOGLE's Gmail platform. Preferably, information is sent as a VCF file, which is automatically recognized as contact information by most PIMs and data associated therewith can be automatically imported to a PIM. There are numerous other methods and systems configurations for adapting the system to be usable across disparate formats/platforms—each of which would suggest themselves to one of ordinary skill in the art and are within the scope of the current invention.

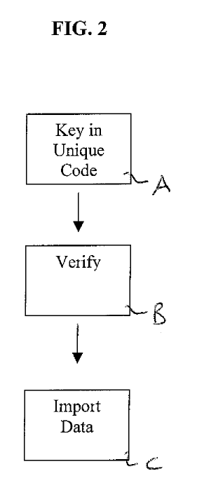

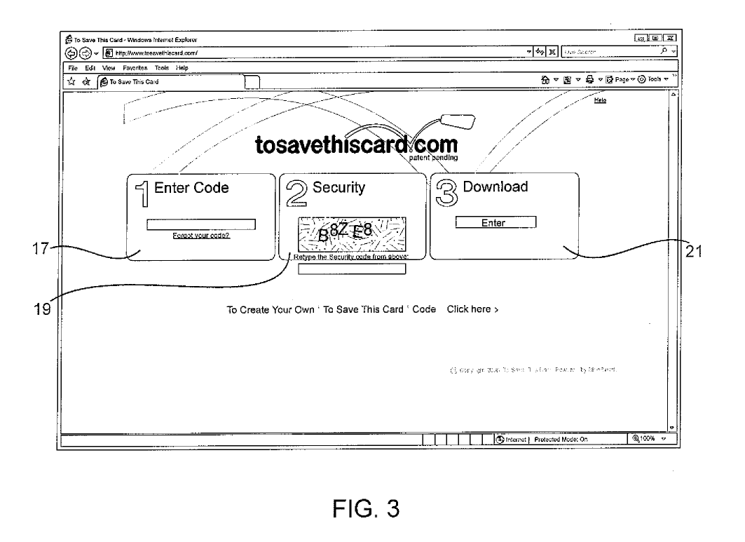

Referring to FIG. 2, in an embodiment of the invention, upon visiting the website 12, a user (recipient) is prompted to execute at least three principal operations for importing contact information represented by a unique code Initially (step A) a user is prompted to enter the unique code To that end, a webpage is configured to provide a designated field for receiving the same. At step B—for security and anti-spam measures—the system is configured to require a user to execute some form of manual verification to verify that he/she is a human being and legitimately accessing the website. A popular mechanism that is widely used for this purpose is the “CAPTCHA” system whereby a user is prompted to key in letters displayed on the webpage. In Step C a user selects to import the data into his/her address book.

In step C, data can be imported in various ways. For example, contact information can be imported directly to a recipient's electronic address book via one of several file types such as CSV (comma separated values) file, VCF (Virtual Card File) file or by way of an Object Linking and Embedding (OLE) program, such as MICROSOFT's Active X Alternatively, contact information could be transferred as a downloadable file. Preferably, a recipient will select the format in which to obtain contact information. It will be understood by those of ordinary skill in the art that there are various ways of importing data into a recipient's contacts—all of which are within the scope and breadth of the current invention.

FIG. 3 shows a screen capture of a webpage that recipients visit to download contact information using a unique code A field 17 is provided in which a user keys in a unique code. A second field 19 is provided for security verification. A third field or icon 21 is provided for a user to authorize the downloading of information.

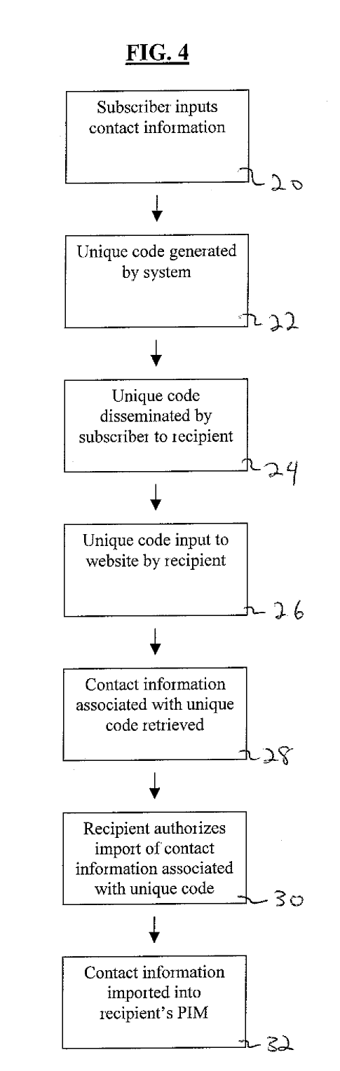

FIG. 4 shows some of the steps for disseminating contact information according to an embodiment of the invention. A subscriber visits a website and enters his/her contact information 20. The website provides the subscriber with designated fields for receiving various contact information. In one preferred embodiment, one website handles both incoming information from subscribers and outgoing information to recipients, but two separate websites may be possible. (For the purposes of this application, it is assumed that one website is utilized and “website” herein refers to the specialized website through which subscribers input contact information and from which recipients import the same.) After inputting contact information, which is then stored in a database, the system generates a unique code 22. The unique code is essentially a shortcut to the information input by a subscriber.

Once a subscriber has successfully obtained a unique code, he/she may disseminate the unique code to recipients 24. A recipient of the unique code then visits the website in order to download the contact information associated therewith. At the website, the recipient is prompted to input the unique code 26 into a designated field The contact information associated with the unique code is the retrieved by the system 28. Preferably, a recipient will then be prompted to authorize the import of information 30, before such information is imported into the recipients PIM 32.

In a preferred embodiment, a subscriber's unique code is sent to each recipient who imports that subscriber's contact information The code could be inserted into any of various fields in the contact form, but preferably it is inserted into a field that is seldom used. In this way, the recipient, at any later time could return to the website and choose to synchronize all contact information in their address book that was imported through the system of this invention.

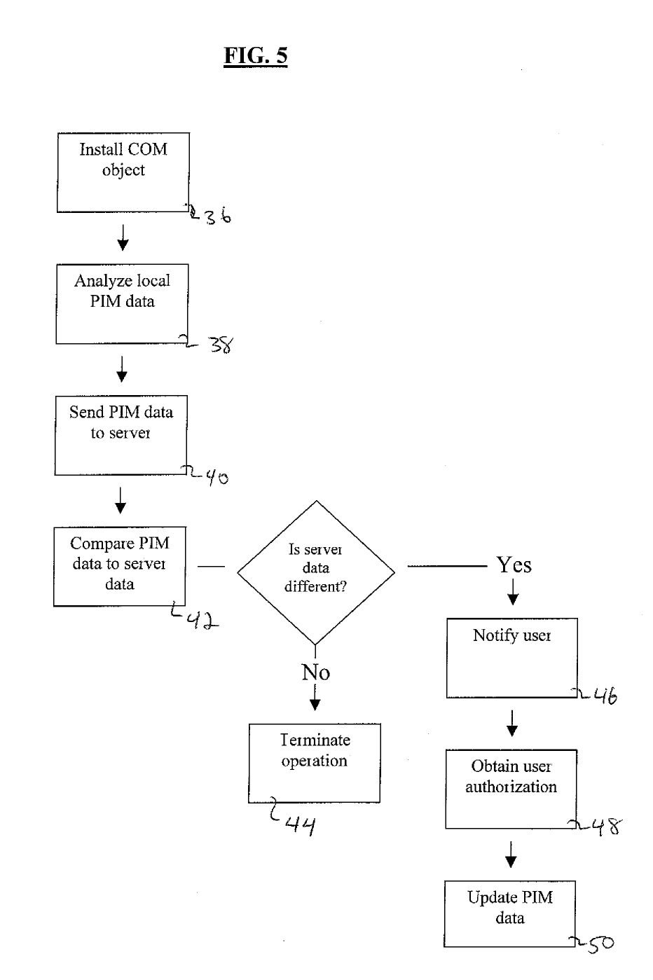

Referring to FIG. 5, in order to synchronize data, a recipient installs a Component Object Model (COM Object), such as MICROSOFT's ActiveX on his/her local computer 36. When prompted, the application initializes a scan 38 of all contact information residing in the recipient's PIM and searches for records containing a unique code as provided by the website. The application then sends all contact information associated with each unique code to the server associated with the website 40. For each unique code, the server then compares the contact information culled from the client machine with the information stored on the server(s) 42. If there is no discrepancy between the information found in the client PIM and the information stored in the server, the synchronization operation is terminated 44, as no updates are necessary. When any field of information on the server(s) is found to be different from information found on the local client machine, the recipient is notified 46 by the website that updates are available. The website then prompts a user to authorize an update 48. Upon the authorization of a user (for example by clicking an “accept” button and or entering “CAPTCHA” information) 48, the information on the client machine that is different from the information on the server is replaced with the more current information from the server. The data is updated 50 as described herein above. This embodiment allows for users to update contact information quickly and efficiently.

Having described this invention with regard to specific embodiments, it is to be understood that the description is not meant as a limitation since further modifications and variations may be apparent or may suggest themselves to those skilled in the art. It is intended that the present application cover all such modifications and variation as fall within the scope of the appended claims.

What is claimed is:

1. A method of transmitting contact information, comprising the steps of:
entering contact information into a database;
generating a unique code said code being associated with said contact information;
disseminating said unique code;
entering said unique code into a website, said website accessing said contact information associated with said unique code; and
transmitting said contact information to a personal information manager (PIM).

2. The method of claim 1, wherein said contact information is entered by a subscriber and said contact information is transmitted to a recipient.

3. The method of claim 1, wherein said contact information entered into said database is keyed in to a webpage on a website

4. The method of claim 1, wherein said contact information is transmitted as a VCF file

5. The method of claim 1, wherein said contact information is transmitted as a CSV file.

6. The method of claim 1, wherein said contact information is transmitted by way of an Object Linking and Embedding program.

7. The method of claim 1, further comprising the step of synchronizing contact information in said personal information manager with contact information located on a server.

8. The method of claim 7, wherein said synchronization step comprises the steps of:
searching a personal information manager for a unique code;
sending first information associated with said unique code, said first information taken from a PIM;
comparing said first information with second information, said second information comprising information associated with said unique code residing on a server; and
transmitting updated information to a user if said first information is different from said second information.
